(19) United States
(12) Patent Application Publication
(10) Pub. No.: US 2016/0160809 A1
(43) Pub. Date: Jun. 9, 2016

(54) VANE PUMP AND LEAKAGE DETECTING DEVICE USING THE SAME

(71) Applicant: DENSO CORPORATION, Kariya-city (JP)

(72) Inventors: Shigeru HASEGAWA, Kariya-city (JP); Yasuo Kato, Kariya-city (JP); Tomohiro Itoh, Kariya-city (JP); Kosei Takagi, Kariya-city (JP); Ryoyu Kishi, Kariya-city (JP)

(21) Appl. No.: 14/959,504

(22) Filed: Dec. 4, 2015

(30) Foreign Application Priority Data
Dec. 5, 2014 (JP) 2014-247018

(51) Int. Cl. F02M 25/08; F04C 29/00; F04C 18/344

(52) U.S. Cl. CPC F02M 25/0818; F04C 18/3448; F04C 29/0085; F02M 25/0854

(57) ABSTRACT

The vane pump has a pump chamber, in which a first inner plate and a second inner plate are movably accommodated at each of axial ends of a rotor. In a case that an electric motor is arranged at a lower side of the vane pump, the first inner plate is moved in a direction to the second inner plate by a force of gravity, so that the first inner plate is brought into contact with a first axial end of the rotor. As a result, an upper side axial open end of each pumping room, which is respectively defined by multiple vanes, is closed by the first inner plate. An amount of air leaking from one of the pumping rooms to the other pumping rooms can be reduced.

### CROSS REFERENCE TO RELATED APPLICATION

This application is based on Japanese Patent Application No. 2014-247018 filed on Dec. 5, 2014, the disclosure of which is incorporated herein by reference.

### FIELD OF TECHNOLOGY

The present disclosure relates to a vane pump and a leakage detecting device for fuel vapor using the vane pump.

### BACKGROUND

A fuel vapor treating system is known in the art, according to which fuel vapor vaporized from a fuel tank is collected and supplied into an air-intake system of an internal combustion engine. The fuel vapor treating system of the prior art has a leakage detecting device for detecting leakage of the fuel vapor from the fuel tank and/or a canister. The leakage detecting device has a vane pump for increasing or decreasing pressure in the fuel tank and the canister, a change-over valve for switching a communication mode of an inside of the fuel tank or the canister to the vane pump to another communication mode of the inside of the fuel tank or the canister to the atmosphere, a pressure sensor for detecting pressure in the fuel tank or the canister, and so on.

A vane pump, which is disclosed in Japanese Patent Publication No. 2011-047324, has a housing for a pump chamber, a rotor and vanes rotatably accommodated in the pump chamber, an electric motor for rotating the rotor, a pair of cover plates each of which is movable in the pump chamber and respectively brought into contact with an axial end of the rotor, and so on.

In the above vane pump, each of the cover plates has a through-hole, through which a shaft and a bearing for supporting the shaft are inserted. An outer diameter of the bearing is relatively large. Therefore, a gap formed at the trough-hole between the cover plate and the bearing in a radial direction inevitably becomes larger. Then, a relatively large amount of fluid may leak through the gap from pumping rooms defined in the pump chamber by the multiple vanes. When the fluid of an large amount leaks from the pumping rooms, an air suction characteristic or an air discharge characteristic of the vane pump is decreased.

### SUMMARY OF THE DISCLOSURE

The present disclosure is made in view of the above problem. It is an object of the present disclosure to provide a vane pump, according to which variation of an air suction characteristic and/or an air discharge characteristic of the vane pump is reduced to thereby improve those characteristics.

According to one of features of the present disclosure, a vane pump is composed of;

a pump housing having a pump chamber;

a rotor rotatably accommodated in the pump housing and having a shaft-fixing hole extending in an axial direction of the rotor and multiple vane grooves, each of which extends in a radial-inward direction of the rotor;

multiple vanes, each of which is movably accommodated in the respective vane groove so that each vane is movable in a radial direction of the rotor and in the axial direction of the rotor, each of the vanes being slidable on an inner surface of the housing which forms the pump chamber;

an electric motor having a shaft inserted into the shaft-fixing hole and rotating the rotor;

a first inner plate movably accommodated in the pump chamber between a first axial-end wall of the housing and the rotor as well as the vanes, so that the first inner plate is movable in the axial direction of the rotor in a first space formed between the first axial-end wall and the rotor as well as the vanes, the first space being formed in the pump chamber on an axial side opposite to the electric motor in the axial direction of the rotor; and

a second inner plate movably accommodated in the pump chamber between a second axial-end wall of the housing and the rotor as well as the vanes, so that the second inner plate is movable in the axial direction of the rotor in a second space formed between the second axial-end wall and the rotor as well as the vanes, the second space being formed in the pump chamber on the other axial side to the electric motor in the axial direction of the rotor, the second inner plate having a shaft-insertion through-hole through which the shaft of the electric motor is inserted into the rotor.

According to the above feature of the present disclosure, the vane pump has the first and the second inner plates at both axial ends of the rotor in the axial direction. Each of the first and the second inner plates is movably accommodated in the axial direction. Each of axial open ends of multiple pumping rooms, which are formed in the pump chamber and defined by the multiple vanes, is closed by the respective first and the second inner plates. It is, therefore, possible to make smaller variation of an amount of air leaking from one of the pumping rooms to the other pumping rooms.

In addition, the first inner plate does not have a through-hole, through which a shaft or the like (for example, a bearing) is inserted. When compared with the vane pump of the above explained prior art (JP 2011-047324), in which each of the cover plates has the through-hole through which the bearing is inserted, it is possible in the vane pump of the present disclosure to make smaller the amount of the air leaking from the pumping rooms.

In addition, in the vane pump of the present disclosure, the second inner plate has the shaft-insertion through-hole through which only the shaft of the electric motor is inserted. When compared with the vane pump of the above prior art (JP 2011-047324), in which each of the cover plates has the through-hole for the bearing having an outer diameter larger than that of the shaft, it is possible in the vane pump of the present disclosure to make smaller the amount of the air leaking from the pumping rooms through a gap formed between the shaft-insertion through-hole of the second inner plate and the shaft of the electric motor.

Accordingly, in the vane pump of the present disclosure, it is possible to make variation of the air leaking amount from the pumping rooms smaller by the first and/or the second inner plates, each of which respectively closes the axial open ends of the pumping rooms in the axial direction. In addition, since the first inner plate has no through-hole, while the second inner plate has the through-hole of a relatively small inner diameter, it is possible to make smaller the air leaking amount from the pumping rooms via the gap formed at the through-hole between the second inner plate and the shaft. As above, it is possible to make variation of air suction characteristic and/or air discharge characteristic of the vane pump smaller. Furthermore, the air suction characteristic and/or the air discharge characteristic of the vane pump can be improved.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view showing a leakage detecting system for fuel vapor using a vane pump according to a first embodiment of the present disclosure;

FIG. 2 is a schematic cross sectional view, taken along a line II-II in FIG. 4, showing a detailed structure of the vane pump of the first embodiment;

FIG. 3 is a schematic cross sectional view showing the detailed structure of the vane pump of the first embodiment, wherein the vane pump is shown in an upside-down condition in a vertical direction;

FIG. 4 is a schematic plane view showing the vane pump, when viewed it in a direction of an arrow IV in FIG. 2;

FIG. 5 is a schematic cross sectional view showing a detailed structure of the vane pump according to a second embodiment of the present disclosure;

FIG. 6 is a schematic cross sectional view showing a detailed structure of the vane pump according to a third embodiment of the present disclosure;

FIG. 7 is a schematic cross sectional view showing a detailed structure of the vane pump according to a fourth embodiment of the present disclosure;

FIG. 8 is a schematic cross sectional view showing a detailed structure of the vane pump according to a fifth embodiment of the present disclosure;

FIG. 9 is a schematic cross sectional view showing a detailed structure of the vane pump according to a sixth embodiment of the present disclosure;

FIG. 10 is a schematic cross sectional view showing a detailed structure of the vane pump according to a seventh embodiment of the present disclosure; and

FIGS. 11 and 12 are schematic cross sectional views, each of which shows a detailed structure of the vane pump according to modifications of the present disclosure.

### DETAILED DESCRIPTION OF THE EMBODIMENTS

The present disclosure will be explained hereinafter by way of multiple embodiments and/or modifications with reference to the drawings. The same reference numerals are given to the same or similar structure and/or portion throughout the multiple embodiments in order to avoid repeated explanation.

### First Embodiment

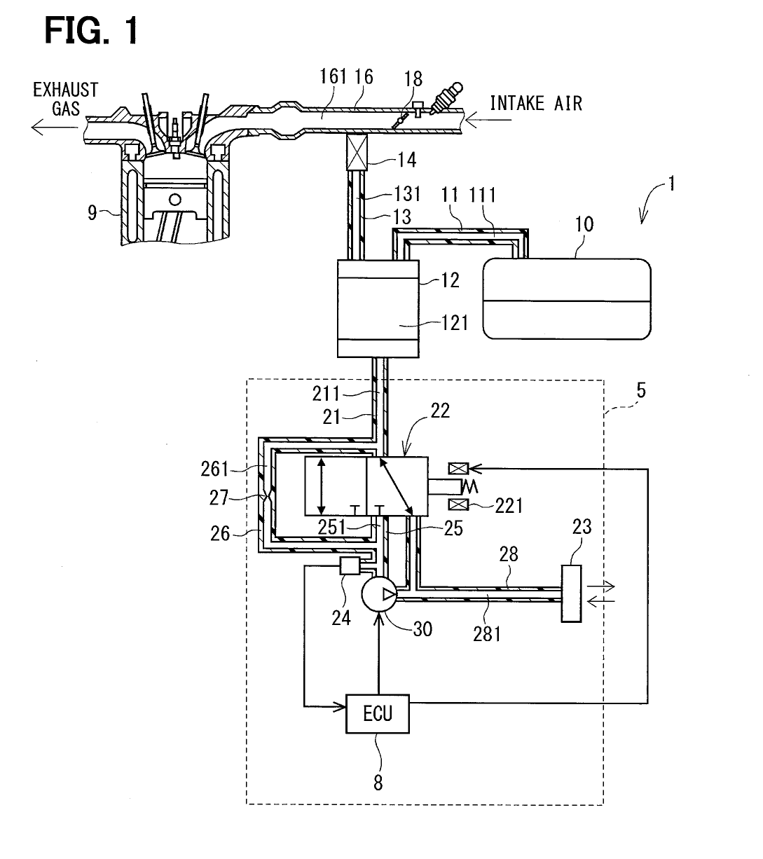

A vane pump 30 of a first embodiment of the present disclosure will be explained with reference to FIGS. 1 to 4.

At first, a leakage detecting device 5 for fuel vapor using the vane pump 30 will be explained with reference to FIG. 1. A fuel vapor treating system 1 has the leakage detecting device 5.

The fuel vapor treating system 1 is composed of a fuel tank 10, a canister 12, a purge valve 14, the leakage detecting device 5 and so on. In the fuel vapor treating system 1, fuel vapor generated in the fuel tank 10 is collected in the canister 12. The fuel vapor collected by the canister 12 is then supplied into an intake-air passage 161 formed by an intake pipe 16, which is connected to an internal combustion engine 9 (hereinafter, the engine 9).

The fuel tank 10 stores fuel to be supplied to the engine 9. The fuel tank 10 is connected to the canister 12 via a connecting pipe 11, which forms a communication passage 111 communicating an inside of the fuel tank 10 to an inside of the canister 12.

The canister 12 has absorbing material 121 for collecting the fuel vapor generated in the fuel tank 10. The canister 12 is connected to the intake pipe 16 via a purge pipe 13 having a purge passage 131.

The purge valve 14 is composed of an electromagnetic valve and provided in the purge pipe 13. An amount of the fuel vapor, which is purged from the canister 12 into the intake-air passage 161 at a downstream side of a throttle valve 18, is controlled by adjusting an opening degree of the purge valve 14.

The leakage detecting device 5 for the fuel vapor is composed of a canister connecting pipe 21, the vane pump 30, a pressure sensor 24 (a pressure detecting device), a pressure detection pipe 25, an atmosphere communication pipe 28, a change-over valve 22, a bypass pipe 26, a reference orifice 27, an air filter 23, an electronic control unit 8 (the ECU 8), and so on. The leakage detecting device 5 decreases pressure in the fuel tank 10 and the canister 12 by the vane pump 30 in order to detect a possible leakage of the fuel vapor from the fuel tank 10 and/or the canister 12.

The canister connecting pipe 21 forms a canister connecting passage 211, which communicates the canister 12 to the change-over valve 22. The bypass pipe 26 is connected to the canister connecting pipe 21, so that a bypass passage 261 formed in the bypass pipe 26 communicates the canister connecting passage 211 to a pressure detection passage 251 without passing through the change-over valve 22.

The vane pump 30 is connected to the pressure detection pipe 25 and the atmosphere communication pipe 28. The vane pump 30 is electrically connected to the ECU 8 and operated by a control signal from the ECU 8. The vane pump 30 draws the air from the fuel tank 10 and the canister 12. A detailed structure of the vane pump 30 will be explained below.

The pressure detection pipe 25 connects the vane pump 30 to the change-over valve 22. The bypass pipe 26 is connected to an intermediate point of the pressure detection pipe 25. The pressure sensor 24 is provided in the pressure detection pipe 25 in order to detect pressure in the pressure detection passage 251 formed by the pressure detection pipe 25.

The air filter 23 is provided in the atmosphere communication pipe 28, which is connected to the vane pump 30 and the change-over valve 22. The air sucked by the vane pump 30 from the fuel tank 10 or the canister 12 flows into an atmosphere communication passage 281 formed in the atmosphere communication pipe 28 in a direction from the vane pump 30 to the air filter 23. In addition, the air flows through the atmosphere communication passage 281 in a direction from the air filter 23 to the change-over valve 22, when the fuel vapor absorbed in the canister 12 is supplied into the intake pipe 16.

The change-over valve 22 is composed of an electromagnetic valve electrically connected to the ECU 8. The change-over valve 22 switches over a first communication mode between the canister connecting passage 211 and the atmosphere communication passage 281 to a second communication mode between the canister connecting passage 211 and the pressure detection passage 251, or vice versa, depending on a power supply from the ECU 8 to a coil 221 of the change-over valve 22.

The reference orifice 27 is formed in the bypass pipe 26. The reference orifice 27 has an inner diameter, which corresponds to a maximum diameter for an acceptable amount of leakage for the air (including the fuel vapor) from the fuel tank 10.

The air filter 23 is provided at an end of the atmosphere communication pipe 28 on a side to the atmosphere. The air filter 23 removes extraneous material contained in the air, which is introduced from the atmosphere into the fuel vapor treating system 1. Each of arrows in FIG. 1 indicates respective flow directions of the air passing through the air filter 23 from the atmosphere to the fuel vapor treating system 1 or vice versa.

The ECU 8 is composed of a micro-computer, which has a CPU as a calculating portion, a RAM and/or a ROM as a memory device, and so on. The ECU 8 is electrically connected to the pressure sensor 24, the vane pump 30 and the coil 221 of the change-over valve 22. A detection value of the pressure sensor 24, which depends on the pressure in the pressure detection passage 251, is inputted to the ECU 8 and memorized in the memory device. The ECU 8 outputs a control signal for operating the vane pump 30. In addition, the ECU 8 controls power supply to the coil 221 of the change-over valve 22.

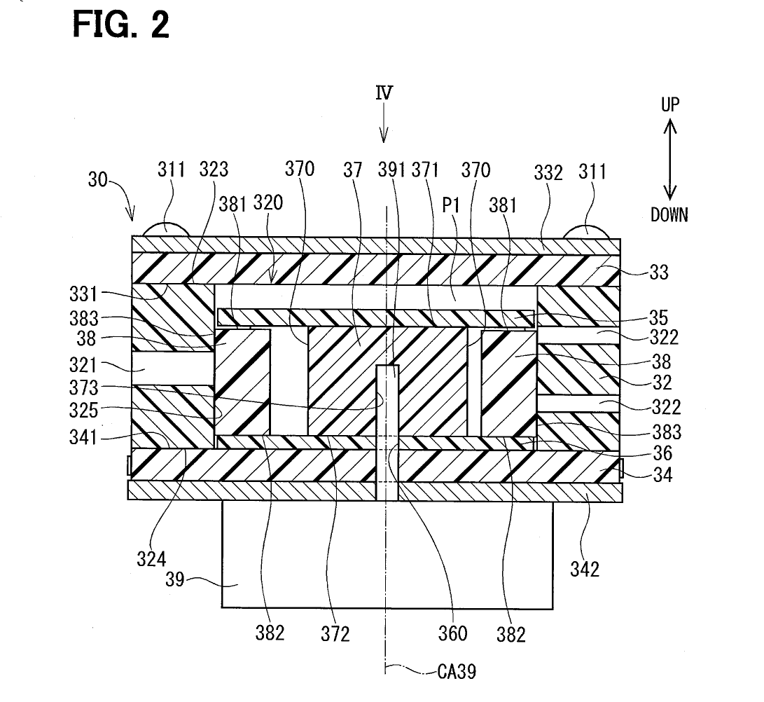

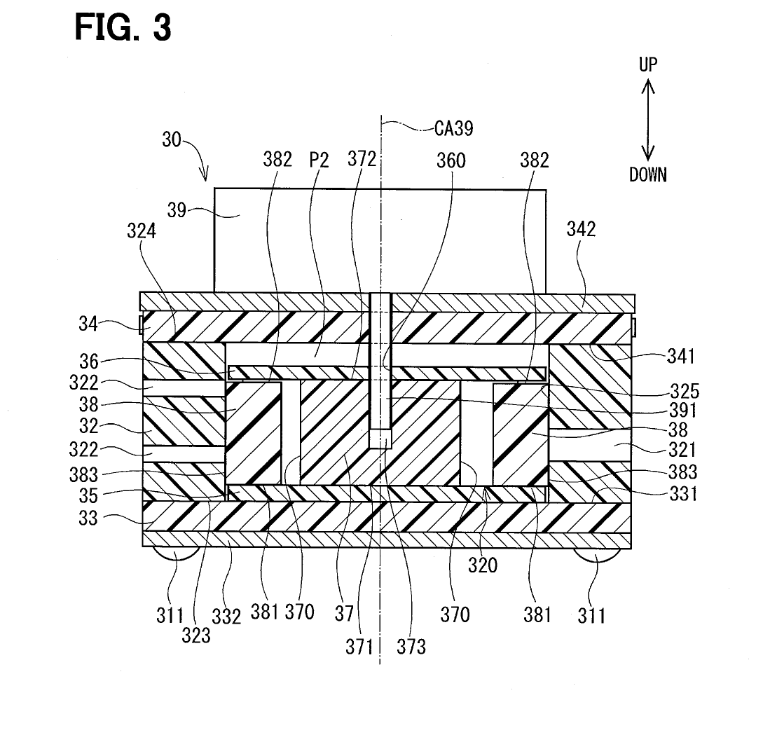

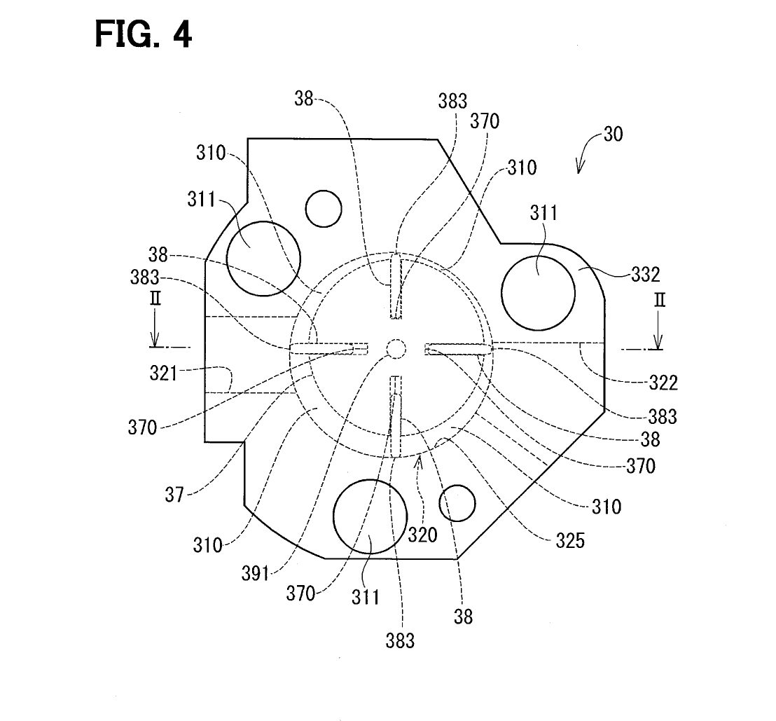

A detailed structure of the vane pump 30 will be explained with reference to FIGS. 2 to 4. FIG. 2 is a cross sectional view showing the vane pump 30 in a condition that an electric motor 39 is located on a lower side of the vane pump 30 in a vertical direction. FIG. 3 is a cross sectional view showing the vane pump 30, when the electric motor 39 is located on an upper side of the vane pump 30 in the vertical direction. FIG. 4 is a top plane view of the vane pump 30, when viewed it in a direction of an arrow IV in FIG. 2, that is, in a direction of a rotating axis CA39 of a rotor 37 of the vane pump 30 from a side opposite to the electric motor 39 (that is, from an upper side in FIG. 2). The direction of the rotating axis CA39 is also referred to as the axial direction.

The vane pump 30 is a pump driven by a brushless direct-current motor (the electric motor 39). The vane pump 30 is composed of a cam ring 32, a first outer plate 33 (a first axial-end wall 33), a second outer plate 34 (a second axial-end wall 34), the rotor 37, multiple vanes 38, a first inner plate 35 (a first cover member), a second inner plate 36 (a second cover member), the electric motor 39 and so on.

The cam ring 32, the first outer plate 33 and the second outer plate 34 are collectively referred to as a pump housing.

The cam ring 32 is made of resin and formed in a cylindrical shape. The cam ring 32 has a pump chamber 320, a suction port 321 and a pair of discharge ports 322.

The pump chamber 320 extends in the cam ring 32 in an axial direction (a direction of the rotating axis CA39). The rotor 37 is rotatably accommodated in the pump chamber 320, as explained below.

The suction port 321 is formed in the cam ring 32 at an intermediate portion in the axial direction of the pump housing between a first axial end surface 323 of the cam ring 32 (on a side to the first outer plate 33) and a second axial end surface 324 of the cam ring 32 (on a side to the second outer plate 34). The suction port 321 communicates the pump chamber 320 to the pressure detection passage 251. According to the above structure, vibration of the rotor 37, which may be caused by pressure difference of the air sucked into the pump chamber 320 through the suction port 321, can be decreased.

Two discharge ports 322 are formed in the cam ring 32 at such positions, which are opposite to the suction port 321 in a radial direction of the cam ring 32 across the rotating axis CA39. The discharge ports 322 communicate the pump chamber 320 to the atmosphere communication passage 281.

Multiple bolt holes (not shown) are formed in the cam ring 32, each of which extends in the direction of the rotating axis CA39 (that is, in the axial direction of the pump housing). A bolt 311 is inserted into each of the bolt holes in order to fix the first outer plate 33, the cam ring 32, the second outer plate 34 and the electric motor 39 to one another by a screw tightening force.

The first outer plate 33, which is made of resin, is fixed to an axial end (that is, to the first axial end surface 323) of the cam ring 32 on a side opposite to the electric motor 39. The first outer plate 33 closes one of axial open ends (a first axial open end) of the pump chamber 320 on the side opposite to the electric motor 39. A first axial-inside end surface 331 of the first outer plate 33, that is, an axial end surface on a side to the cam ring 32, is in contact with the first axial end surface 323 of the cam ring 32.

A first protection plate 332 is provided at a first axial-outside end surface of the first outer plate 33. The first protection plate 332 is provided for the purpose of preventing the first outer plate 33 from being broken by the screw tightening force of the bolts 311, when the first outer plate 33 is firmly fixed to the cam ring 32.

The second outer plate 34, which is also made of resin, is fixed to the other axial end (that is, the second axial end surface 324) of the cam ring 32 on a side to the electric motor 39. The second outer plate 34 closes the other of the axial open ends (a second axial open end) of the pump chamber 320 on the side to the electric motor 39. A second axial-inside end surface 341 of the second outer plate 34, that is, an axial end surface on a side to the cam ring 32, is in contact with the second axial end surface 324 of the cam ring 32.

A second protection plate 342 is likewise provided between the second outer plate 34 and the electric motor 39. The second protection plate 342 is provided for the purpose of preventing the second outer plate 34 from being broken by the screw tightening force of the bolts 311, when the second outer plate 34 is firmly fixed to the cam ring 32.

The rotor 37 is a cylindrical member, which is rotatably accommodated in the pump chamber 320. The rotor 37 has a shalt-insertion hole 373 extending in the direction of the rotating axis CA39. A forward end of a shaft 391 of the electric motor 39 is inserted into the shaft-fixing hole 373. The rotor 37 is rotated together with the shaft 391 in a forward rotating direction for sucking the air from the fuel tank 10 and the canister 12.

As shown in FIG. 4, multiple vane grooves 370 are formed at an outer periphery of the rotor 37, wherein each of the vane grooves 370 extends in a radial-inward direction of the rotor 37 from its outer periphery and passes through the rotor 37 in the direction of the rotating axis CA39. The multiple vane grooves 370 are formed at equal intervals in a circumferential direction of the rotor 37. Each of the vanes 38 is movably accommodated in the respective vane groove 370.

Each of the vanes 38 is movable in the vane groove 370 with respect to the rotor 37 in the radial direction and in the axial direction (the direction of the rotating axis CA39). In the present embodiment, four vanes 38 are provided. When the rotor 37 is rotated, each of the vanes 38 is moved in the radial-outward direction, so that a radial-outside end 383 of the vane 38 is brought into contact with an inner peripheral surface 325 of the cam ring 32 (an inner peripheral surface of the pump housing). The radial-outside end 383 of the vane 38 slides on the inner peripheral surface 325 of the cam ring 32. According to the above structure, the pump chamber 320 is divided into four pumping rooms 310.

In the vane pump 30 of the present embodiment, an axial length of the rotor 37 as well as an axial length of each vane 38 (a length in the direction of the rotating axis CA39) is made smaller than an axial length of the cam ring 32, that is, a distance between the first axial end surface 323 and the second axial end surface 324 of the cam ring 32, in order that the rotor 37 and the vanes 38 can be smoothly rotated in the pump chamber 320 without a stress, such as, a friction. Therefore, in the case that the electric motor 39 is located at the lower side of the vane pump 30 in the vertical direction, as shown in FIG. 2, each of the rotor 37 and the vanes 38 is moved by force of gravity in the axial direction to the second outer plate 34 together with the second inner plate 36, that is, in a direction to the lower side of the vane pump 30 in the vertical direction. As a result, a first space “P1” is formed between the first axial-inside end surface 331 of the first outer plate 33 and a first axial end surface 371 of the rotor 37 (on a side to the first outer plate 33) and between the first axial-inside end surface 331 of the first outer plate 33 and a first axial end surface 381 of each vane 38 (on the side to the first outer plate 33).

On the other hand, as shown in FIG. 3, in the case that the electric motor 39 is located at an upper side of the vane pump 30 in the vertical direction, each of the rotor 37 and the vanes 38 is moved by force of gravity in a direction to the first outer plate 33 together with the first inner plate 35, that is, in a direction to the lower side of the vane pump 30 in the vertical direction.

As a result, a second space “P2” is formed between the second axial-inside end surface 341 of the second outer plate 34 and a second axial end surface 372 of the rotor 37 (on a side to the second outer plate 34) and between the second axial-inside end surface 341 of the second outer plate 34 and a second axial end surface 382 of each vane 38 (on the side to the second outer plate 34).

In FIGS. 2 and 3, the axial length of the rotor 37 as well as the axial length of the vanes 38 in the direction of the rotating axis CA39 relative to the axial length of the cam ring 32 (that is, the distance between the first and the second axial end surfaces 323 and 324 of the cam ring 32) is indicated as a value smaller than an actual value thereof, so that the first space “P1” and the second space “P2” can be easily recognized.

The first inner plate 35 is a disc-shaped plate member, which is provided in the pump chamber 320, more exactly, in the first space “P1” between the first outer plate 33 and the rotor 37 as well as the vanes 38. An outer diameter of the first inner plate 35 is smaller than an inner diameter of the pump chamber 320. The first inner plate 35, which is movably accommodated in the pump chamber 320 in the direction of the rotating axis CA39, is operatively in contact with the first axial end surface 371 of the rotor 37.

The second inner plate 36 is also a disc-shaped plate member, which is provided in the pump chamber 320, that is, in the second space “P2” between the second outer plate 34 and the rotor 37 as well as the vanes 38. A shaft-insertion through-hole 360 is formed in the second inner plate 36, so that the shaft 391 of the electric motor 39 passes through the shaft insertion through-hole 360. An outer diameter of the second inner plate 36 is likewise smaller than the inner diameter of the pump chamber 320. The second inner plate 36, which is movably accommodated in the pump chamber 320 in the direction of the rotating axis CA39, is operatively in contact with the second axial end surface 372 of the rotor 37.

The electric motor 39 has the shaft 391, which is inserted into the shaft-fixing hole 373 of the rotor 37 through the shaft-insertion through-hole 360 of the second inner plate 36. The electric motor 39 generates a rotating torque for rotating the shaft 391, when the electric power is supplied thereto from the outside.

An operation of the leakage detecting device 5 for the fuel vapor will be explained hereinafter.

When a predetermined time has passed over since an operation of the engine 9 installed in a vehicle is stopped, the ECU 8 is activated by a soak timer (not shown). At first, the atmospheric pressure is detected in order to compensate an error caused by an altitude of a vehicle parking place. As shown in FIG. 1, the atmosphere communication passage 281 is communicated to the canister connecting passage 211 through the change-over valve 22, when no electric power is supplied to the coil 221 of the change-over valve 22. The canister connecting passage 211 is communicated to the pressure detection passage 251 via the bypass passage 261. Namely, the pressure detection passage 251 is communicated to the atmosphere via the reference orifice 27. Therefore, the atmospheric pressure is detected by the pressure sensor 24 provided in the pressure detection pipe 25. When the atmospheric pressure is detected, the ECU 8 calculates the altitude of the vehicle parking place based on the detected atmospheric pressure.

When the electric power is supplied to the vane pump 30 and the vane pump 30 is operated, the pressure in the pressure detection passage 251 is decreased. When the pressure in the pressure detection passage 251 is decreased, the air flows from the atmosphere into the pressure detection passage 251 via the atmosphere communication passage 281, the change-over valve 22, the canister connecting passage 211 and the bypass passage 261. Since a flow of the air flowing into the pressure detection passage 251 is restricted by the reference orifice 27, the pressure in the pressure detection passage 251 (that is, the passage at a downstream side of the reference orifice 27) becomes lower than the pressure in the atmosphere communication passage 281 (that is, the passage at an upstream side of the reference orifice 27). The pressure in the pressure detection passage 251 becomes stable at a constant value, after it is decreased to a predetermined pressure, which corresponds to an opening area of the reference orifice 27. The detected pressure in the pressure detection passage 251 is memorized in the memory device of the ECU 8 as a reference pressure.

After the above reference pressure is detected, the electric power is supplied to the coil 221 of the change-over valve 22. Then, the first communication mode in which the canister connecting passage 211 is communicated to the atmosphere communication passage 281 via the change-over valve 22 is switched to the second communication mode in which the canister connecting passage 211 is communicated to the pressure detection passage 251 via the change-over valve 22. When the canister connecting passage 211 is communicated to the pressure detection passage 251, the pressure in the pressure detection passage 251 becomes equal to the pressure in the fuel tank 10 and the canister 12.

When the canister connecting passage 211 is communicated to the pressure detection passage 251 via the change-over valve 22, the pressure in the fuel tank 10 and the canister 12 is decreased by the vane pump 30.

When the operation of the vane pump 30 is continued and the pressure in the pressure detection passage 251, that is, the pressure in the fuel tank 10 and the canister 12 becomes lower than the reference pressure, the ECU 8 determines that an amount of the leakage of the air (which includes the fuel vapor from the fuel tank 10 or the canister 12) is lower than the acceptable amount of leakage for the air including the fuel vapor.

In other words, when the pressure in the fuel tank 10 and the canister 12 becomes lower than the reference pressure, it can be so regarded that the air does not enter the fuel tank 10 or the canister 12 from the outside or an amount of the air entering the fuel tank 10 or the canister 12 is lower than such an amount which corresponds to an amount of the air passing through the reference orifice 27. Accordingly, the ECU 8 determines that airtightness for the fuel tank 10 and the canister 12 is sufficiently ensured.

On the other hand, when the pressure in the fuel tank 10 and the canister 12 does not become lower than the reference pressure, the ECU 8 determines that the amount of the leakage of the air (which includes the fuel vapor from the fuel tank 10 or the canister 12) is larger than the acceptable amount of leakage.

In other words, when the pressure in the fuel tank 10 and the canister 12 does not become lower than the reference pressure, it is anticipated that the air has entered the fuel tank 10 and the canister 12 from the outside in accordance with the decrease of the pressure in the fuel tank 10 and the canister 12. Accordingly, the ECU 8 determines that the airtightness for the fuel tank 10 and the canister 12 is not sufficiently ensured.

After the ECU 8 finishes its determination regarding the airtightness for the fuel tank 10 and the canister 12, the ECU 8 terminates the power supply to the change-over valve 22 so that the communication mode is changed to the first communication mode, in which the canister connecting passage 211 is communicated to the atmosphere communication passage 281. The ECU 8 confirms the reference pressure again and terminates the power supply to the vane pump 30. When the ECU 8 determines that the pressure in the pressure detection passage 251 is restored to the atmospheric pressure, the ECU 8 terminates the operation of the pressure sensor 24. Namely, a process for detecting the leakage of the fuel vapor is terminated.

The vane pump 30 of the leakage detecting device 5 for the fuel vapor has the first and the second inner plates 35 and 36, which are movable in the pump chamber 320 in the direction of the rotating axis CA39. As shown in FIG. 2, in which the electric motor 39 is located at the lower side of the vane pump 30 in the vertical direction, the first inner plate 35 is moved in the direction to the lower side (that is, to the second inner plate 36) by the force of gravity and brought into contact with the first axial end surface 371 of the rotor 37. As a result, an upper-side open end (that is, a first axial open end closer to the first inner plate 35 in the direction of the rotating axis CA39) of each pumping room 310, which is defined by the respective vanes 38, is closed by the first inner plate 35. In other words, each of the pumping rooms 310 is prevented from being communicated to each other via the first space “P1”. In a similar manner, as shown in FIG. 3, in which the electric motor 39 is located at the upper side of the vane pump 30 in the vertical direction, the second inner plate 36 is moved in the direction to the lower side (that is, to the first inner plate 35) by the force of gravity and brought into contact with the second axial end surface 372 of the rotor 37. As a result, an upper-side open end (that is, a second axial open end closer to the second inner plate 36 in the direction of the rotating axis CA39) of each pumping room 310, which is defined by the respective vanes 38, is closed by the second inner plate 36. Therefore, each of the pumping rooms 310 is prevented from being communicated to each other via the second space “P2”.

According to the above structure, variation of the leakage amount of the air from one pumping room 310 to the other pumping room(s) 310 becomes smaller. It is, therefore, possible to make smaller a variation of the air suction characteristic and a variation of the air discharge characteristic of the vane pump 30.

In the vane pump disclosed in the prior art (JP 2011-047324), the through-hole through which the shaft and/or the bearing are inserted is formed in each of the cover plates, each of which is brought into contact with respective axial ends of the rotor and the vanes. Since the bearing is provided between the shaft and the rotor in its radial direction, an outer diameter of the bearing is larger than that of the shaft. As a result, the gap between the bearing and the cover plate member becomes relatively larger. Then, the amount of fluid leaking from one pumping room to the other pumping room (s) via the gap correspondingly becomes larger. Therefore, the air suction characteristic and/or the air discharge characteristic of the vane pump of the prior art may be decreased.

According to the vane pump 30 of the first embodiment of the present disclosure, however, the first inner plate 35, which is arranged on the axial side of the rotor 37 and the vanes 38 opposite to the electric motor 39 (that is, on the side of the first axial end surfaces 371 and 381), is formed in the disc shape and the first inner plate 35 does not have a through-hole through which the shaft or the like is inserted. In addition, the second inner plate 36, which is arranged on the axial side of the rotor 37 and the vanes 38 closer to the electric motor 39 (that is, on the side of the second axial end surfaces 372 and 382), has a small through-hole (the shaft-insertion through-hole 360) through which only the shaft 391 of the electric motor 39 is inserted. An inner diameter of the shaft-insertion through-hole 360 is, therefore, relatively small. According to the above structure, it is possible to reduce the amount of the air leaking from the pumping room 310 via a gap formed at the shaft-insertion through-hole 360 between the second inner plate 36 and the shaft 391 in the radial direction.

As above, according to the vane pump 30 of the present embodiment, it is possible to make variation of the air leaking amount from the pumping room 310 smaller by the first and/or the second inner plates 35 and/or 36, each of which respectively closes the axial open ends of the pumping rooms 310 in the direction of the rotating axis CA39. In addition, the first inner plate 35 has no through-hole, while the second inner plate 36 has the through-hole (the shaft-insertion through-hole 360) having the relatively small inner diameter. It is, therefore, possible to make the air leaking amount via the gap formed at the shaft-insertion through-hole 360 between the second inner plate 36 and the shaft 391 smaller. In other words, it is possible to make the variation of the air suction characteristic and/or the air discharge characteristic of the vane pump 30 smaller. Furthermore, the air suction characteristic and/or the air discharge characteristic of the vane pump 30 can be improved.

### Second Embodiment

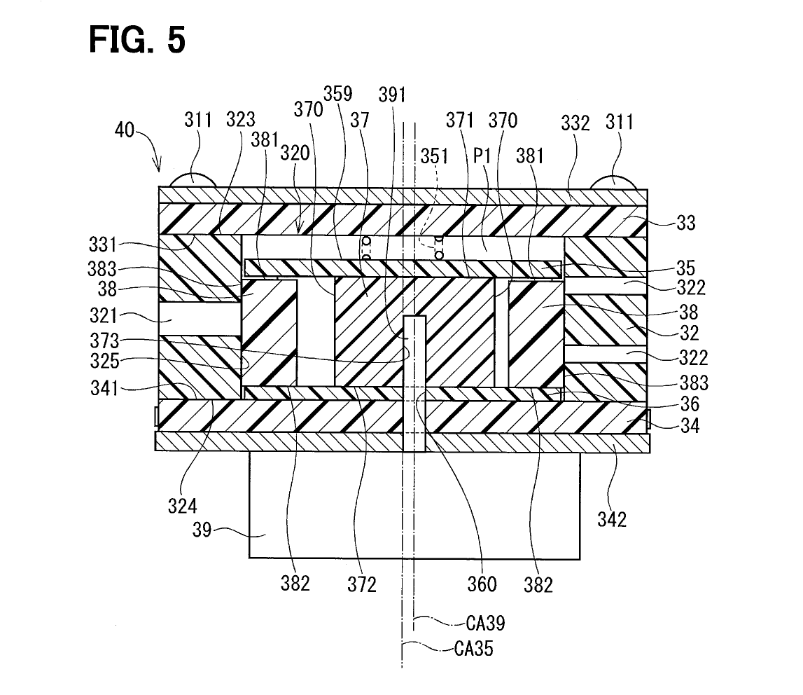

A vane pump 40 according to a second embodiment of the present disclosure will be explained with reference to FIG. 5.

The second embodiment differs from the first embodiment in that a coil spring 351 is provided between the first outer plate 33 and the first inner plate 35.

As shown in FIG. 5, the vane pump 40 of the second embodiment has the coil spring 351 (working as a first biasing member) between the first outer plate 33 and the first inner plate 35. The coil spring 351 is arranged in the pump chamber 320 (in the first space “P1”) coaxially with a center axis CA35 of the first inner plate 35. One end of the coil spring 351 is in contact with the first axial-inside end surface 331 of the first outer plate 33, while the other end of the coil spring 351 is in contact with a first axial-outside end surface 359 of the first inner plate 35. The first axial-outside end surface 359 is formed on a side of the first inner plate 35 facing to the first outer plate 33. The coil spring 351 biases the first inner plate 35 to the rotor 37 and the vanes 38.

In the vane pump 40 of the second embodiment, the first inner plate 35 is pushed by the coil spring 351 to the first axial end surface 371 of the rotor 37. According to the above structure, it is possible to prevent the first inner plate 35 from being separated from the first axial end surface 371 of the rotor 37, even when a position of the vane pump 40 is changed. Therefore, it is possible to stably reduce the variation of the air leaking amount from one pumping room 310 to the other pumping room(s) 310. Accordingly, not only the same advantages to the first embodiment can be obtained in the second embodiment, but also it is possible to reduce a change of the air suction characteristic and/or the air discharge characteristic of the vane pump 40 depending on a change of its position.

In addition, in the vane pump 40 of the second embodiment, the coil spring 351 is coaxially arranged with the center axis CA35 of the first inner plate 35. Therefore, the biasing force of the coil spring 351 is applied to a center of the first inner plate 35. It is, therefore, possible to prevent the first inner plate 35 from being inclined with respect to the rotor 37.

### Third Embodiment

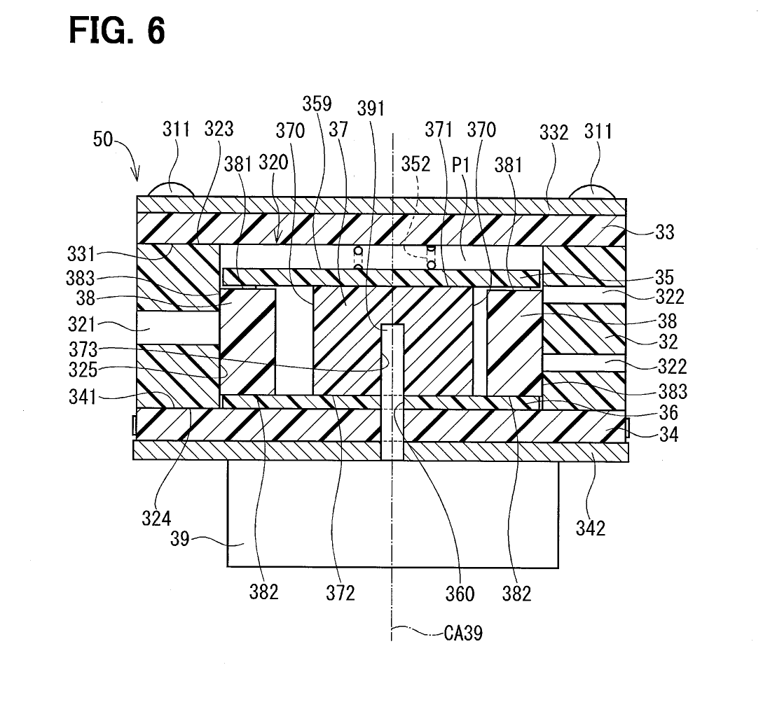

A vane pump 50 according to a third embodiment of the present disclosure will be explained with reference to FIG. 6.

The third embodiment differs from the second embodiment in that a coil spring 352 is provided at a position different from that of the second embodiment.

As shown in FIG. 6 and in a similar manner to the second embodiment, the vane pump 50 of the third embodiment has the coil spring 352 (working as the first biasing member) between the first outer plate 33 and the first inner plate 35. The coil spring 352 is arranged in the pump chamber 320 (in the first space “P1”) coaxially with the rotating axis CA39 of the rotor 37. One end of the coil spring 352 is in contact with the first axial-inside end surface 331 of the first outer plate 33, while the other end of the coil spring 352 is in contact with the first axial-outside end surface 359 of the first inner plate 35. The first axial-outside end surface 359 is formed on the side of the first inner plate 35 facing to the first outer plate 33. The coil spring 352 biases the first inner plate 35 to the rotor 37 and the vanes 38.

In the vane pump 50 of the third embodiment, like the second embodiment, the first inner plate 35 is pushed by the coil spring 352 to the first axial end surface 371 of the rotor 37. According to the above structure, it is possible to prevent the first inner plate 35 from being separated from the first axial end surface 371 of the rotor 37, even when the position of the vane pump 50 is changed. Therefore, it is possible to stably reduce the variation of the air leaking amount from one pumping room 310 to the other pumping room (s) 310. Accordingly, not only the same advantages to the first embodiment can be obtained in the third embodiment, but also it is possible to reduce the change of the air suction characteristic and/or the air discharge characteristic of the vane pump 50 depending on the change of its position.

In addition, in the vane pump 50 of the third embodiment, the coil spring 352 is coaxially arranged with the rotating axis CA39 of the rotor 37. Therefore, the biasing force of the coil spring 352 is applied to a portion of the first inner plate 35 directly above the shaft 391. According to the above structure, it is possible to prevent the first inner plate 35 (which is in contact with the rotor 37) from being rotated by the rotation of the rotor 37.

### Fourth Embodiment

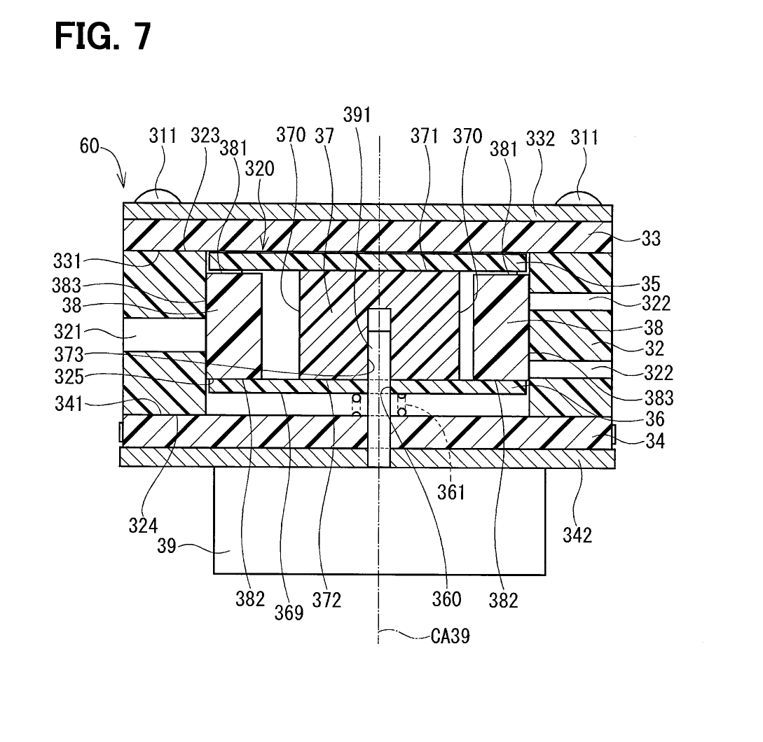

A vane pump 60 according to a fourth embodiment of the present disclosure will be explained with reference to FIG. 7.

The fourth embodiment differs from the first embodiment in that a coil spring 361 is provided between the second outer plate 34 and the second inner plate 36.

As shown in FIG. 7, the vane pump 60 of the fourth embodiment has the coil spring 361 (working as a second biasing member) between the second outer plate 34 and the second inner plate 36. The coil spring 361 is arranged in the pump chamber 320 (in the second space “P2”) in such a way that the coil spring 361 surrounds a part of the shaft 391. One end of the coil spring 361 is in contact with the second axial-inside end surface 341 of the second outer plate 34, while the other end of the coil spring 361 is in contact with a second axial-outside end surface 369 of the second inner plate 36. The second axial-outside end surface 369 is formed on a side of the second inner plate 36 facing to the second outer plate 34. The coil spring 361 biases the second inner plate 36 to the rotor 37 and the vanes 38.

In a similar manner to the second and the third embodiments, in the vane pump 60 of the fourth embodiment, the second inner plate 36 is pushed by the coil spring 361 to the second axial end surface 372 of the rotor 37. According to the above structure, it is possible to prevent the second inner plate 36 from being separated from the second axial end surface 372 of the rotor 37, even when the position of the vane pump 60 is changed. Therefore, it is possible to stably reduce the variation of the air leaking amount from one pumping room 310 to the other pumping room (s) 310. Accordingly, not only the same advantages to the first embodiment can be obtained in the fourth embodiment, but also it is possible to reduce the change of the air suction characteristic and/or the air discharge characteristic of the vane pump 60 depending on the change of its position.

In addition, in the vane pump 60 of the fourth embodiment, the coil spring 361 is so arranged as to surround the shaft 391. Therefore, it is possible to prevent the coil spring 361 from being displaced in a radial direction of the vane pump 60 in the second space P2 between the second inner plate 36 and the second outer plate 34. As a result, the biasing force of the coil spring 361 is surely applied to the second inner plate 36, so that the second inner plate 36 is stably in contact with the rotor 37.

### Fifth Embodiment

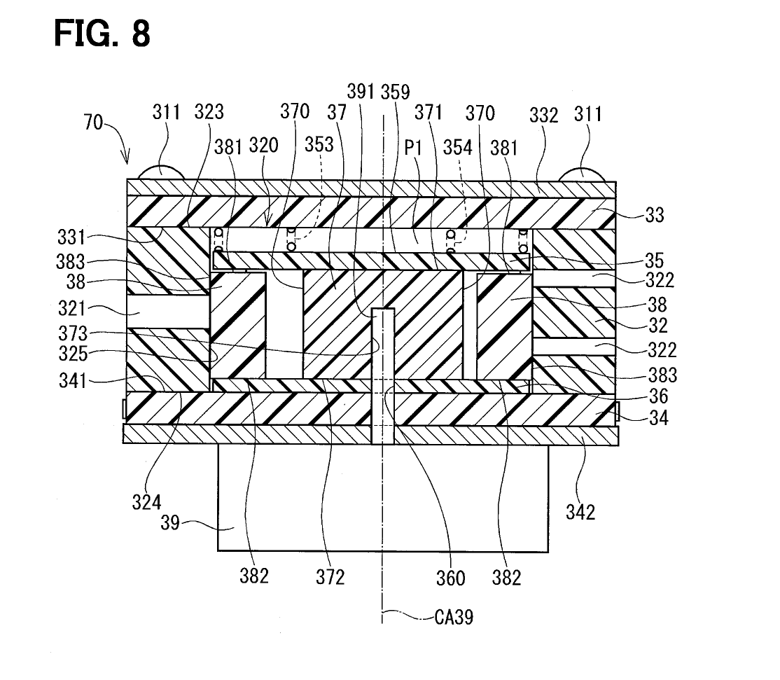

A vane pump 70 according to a fifth embodiment of the present disclosure will be explained with reference to FIG. 8.

The fifth embodiment differs from the first embodiment in that multiple coil springs 353 and 354 are provided in the first space “P1” between the first outer plate 33 and the first inner plate 35.

As shown in FIG. 8, the vane pump 70 of the fifth embodiment has the multiple coil springs 353 and 354 (working as the first biasing members) between the first outer plate 33 and the first inner plate 35. The coil springs 353 and 354 are arranged in the first space “P1” of the pump chamber 320 at such positions, which are symmetric with respect to the rotating axis CA39. One end of each coil spring 353 or 354 is in contact with the first axial-inside end surface 331 of the first outer plate 33, while the other end of each coil spring 353 or 354 is in contact with the first axial-outside end surface 359 of the first inner plate 35. The first axial-outside end surface 359 is formed on the side of the first inner plate 35 facing to the first outer plate 33. Each of the coil springs 353 and 354 biases the first inner plate 35 to the rotor 37 and the vanes 38.

According to the vane pump 70 of the fifth embodiment, in the same manner to the first embodiment, the first inner plate 35 is pushed by the coil springs 353 and 354 to the first axial end surface 371 of the rotor 37. According to the above structure, it is possible to prevent the first inner plate 35 from being separated from the first axial end surface 371 of the rotor 37, even when the position of the vane pump 70 is changed. Therefore, it is possible to stably reduce the variation of the air leaking amount from one pumping room 310 to the other pumping room(s) 310. Accordingly, not only the same advantages to the first embodiment can be obtained in the fifth embodiment, but also it is possible to reduce the change of the air suction characteristic and/or the air discharge characteristic of the vane pump 70 depending on the change of its position.

In addition, in the vane pump 70 of the fifth embodiment, the coil springs 353 and 354 are arranged at such positions which are symmetric with respect to the rotating axis CA39 of the rotor 37. Therefore, the equal biasing force of the coil springs 353 and 354 is applied to the first inner plate 35. It is, therefore, possible to stably keep a contact condition between the first inner plate 35 and the rotor 37.

### Sixth Embodiment

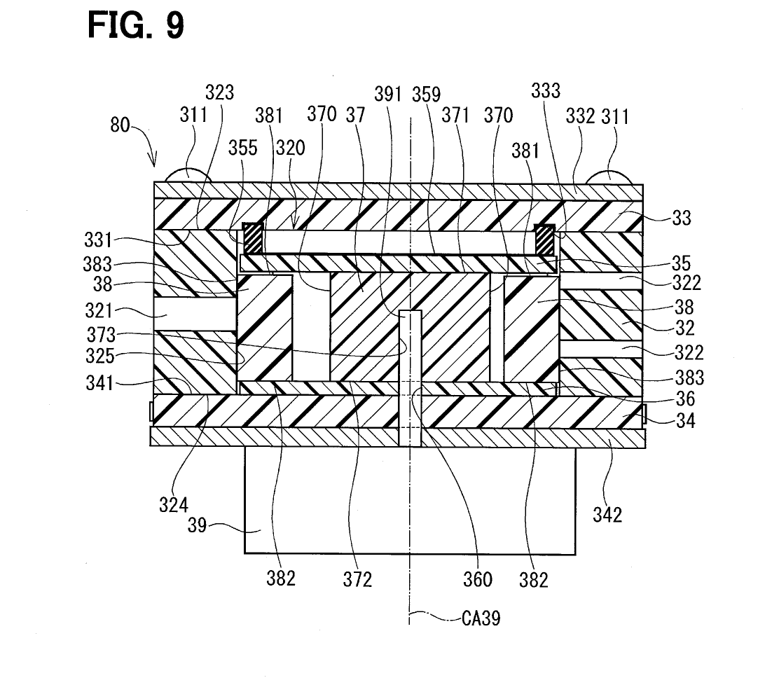

A vane pump 80 according to a sixth embodiment of the present disclosure will be explained with reference to FIG. 9.

The sixth embodiment differs from the first or the second embodiment in that an O-ring 355 made of elastic material is provided in the first space “P1” between the first outer plate 33 and the first inner plate 35.

As shown in FIG. 9, the vane pump 80 of the sixth embodiment has the O-ring 355 (working as the first biasing member) between the first outer plate 33 and the first inner plate 35. The O-ring 355 is made of material having elasticity. An outer diameter of the O-ring 355 is larger than that of the rotor 37 but smaller than that of the first inner plate 35. One axial end of the O-ring 355 is accommodated in a circular groove 333 formed in the first outer plate 33, while the other axial end of the O-ring 355 is in contact with the first axial-outside end surface 359 of the first inner plate 35. In a condition shown in FIG. 9, the O-ring 355 generates a biasing force for pushing the first inner plate 35 to the rotor 37 and the vanes 38.

According to the vane pump 80 of the sixth embodiment, in the same manner to the second embodiment, the first inner plate 35 is pushed by the O-ring 355 so that the first inner plate 35 is in contact with the first axial end surface 371 of the rotor 37. According to the above structure, it is possible to prevent the first inner plate 35 from being separated from the first axial end surface 371 of the rotor 37, even when the position of the vane pump 80 is changed. Therefore, it is possible to stably reduce the variation of the air leaking amount from one pumping room 310 to the other pumping room (s) 310. Accordingly, not only the same advantages to the first embodiment can be obtained in the sixth embodiment, but also it is possible to reduce the change of the air suction characteristic and/or the air discharge characteristic of the vane pump 80 depending on the change of its position.

An axial length of the O-ring 355 (a thickness of the O-ring 355 in the direction of the rotating axis CA39) is made smaller than that of the coil spring 351 of the second embodiment. However, it is possible to apply the biasing force of a predetermined value to the first inner plate 35. Accordingly, it is possible to easily arrange the O-ring 355 in such a narrow space between the first outer plate 33 and the first inner plate 35.

### Seventh Embodiment

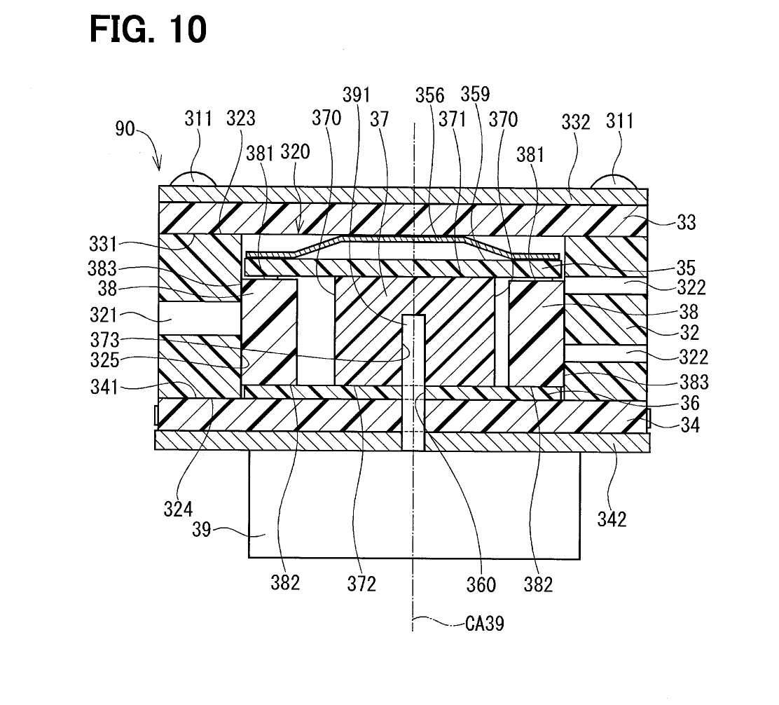

A vane pump 90 according to a seventh embodiment of the present disclosure will be explained with reference to FIG. 10.

The seventh embodiment differs from the first or the second embodiment in that a plate spring 356 is provided in the first space “P1” between the first outer plate 33 and the first inner plate 35.

As shown in FIG. 10, the vane pump 90 of the seventh embodiment has the plate spring 356 of a disc shape (working as the first biasing member) between the first outer plate 33 and the first inner plate 35. An outer diameter of the plate spring 356 is larger than that of the rotor 37 but smaller than that of the first inner plate 35. The plate spring 356 is in contact with the first axial-inside end surface 331 of the first outer plate 33 and the first axial-outside end surface 359 of the first inner plate 35. In a condition shown in FIG. 10, the plate spring 356 generates a biasing force for pushing the first inner plate 35 to the rotor 37 and the vanes 38.

According to the vane pump 90 of the seventh embodiment, in the same manner to the second embodiment, the first inner plate 35 is pushed by the plate spring 356 so that the first inner plate 35 is in contact with the first axial end surface 371 of the rotor 37. According to the above structure, it is possible to prevent the first inner plate 35 from being separated from the first axial end surface 371 of the rotor 37, even when the position of the vane pump 90 is changed. Therefore, it is possible to stably reduce the variation of the air leaking amount from one pumping room 310 to the other pumping room (s) 310. Accordingly, not only the same advantages to the first embodiment can be obtained in the seventh embodiment, but also it is possible to reduce the change of the air suction characteristic and/or the air discharge characteristic of the vane pump 90 depending on the change of its position.

When compared with the coil spring 351 of the second embodiment, it is possible by the plate spring 356 to apply the biasing force of the predetermined value to the first inner plate 35, while an axial length of the plate spring 356 (a thickness of the plate spring 356 in the direction of the rotating axis CA39) is made smaller. Accordingly, it is possible to easily arrange the plate spring 356 in such a narrow space between the first outer plate 33 and the first inner plate 35.

### Further Embodiments and/or Modifications

(M1) In the above embodiments, the vane pump of the present disclosure is applied to the leakage detecting device for the fuel vapor. However, the present disclosure is not limited to those of the embodiments. For example, the vane pump may be applied to any other device, which has a function of increasing and/or decreasing pressure of fluid, including liquid body.

(M2) In the above fourth embodiment (FIG. 7), the coil spring 361 is provided as the second biasing member between the second outer plate 34 and the second inner plate 36. The second biasing member is not limited to the coil spring 361.

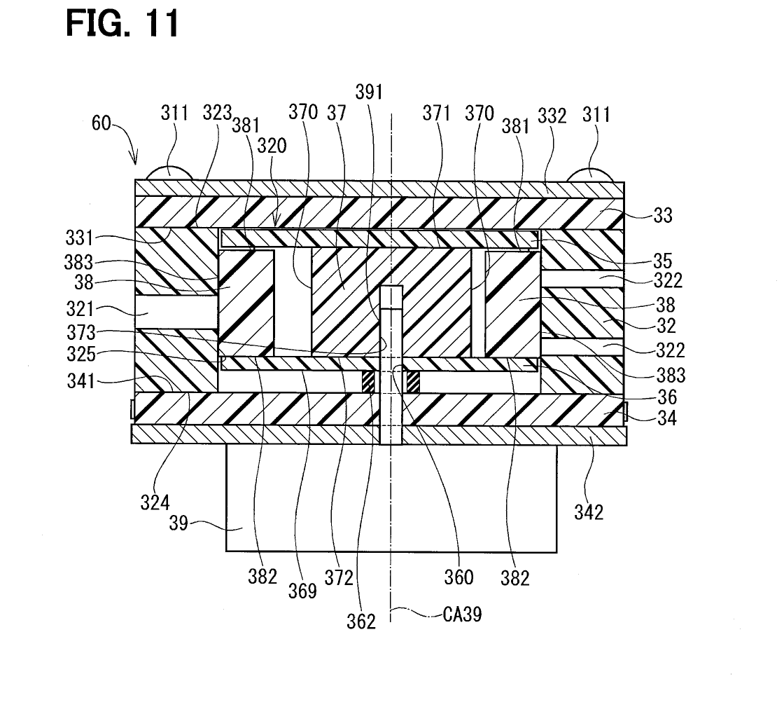

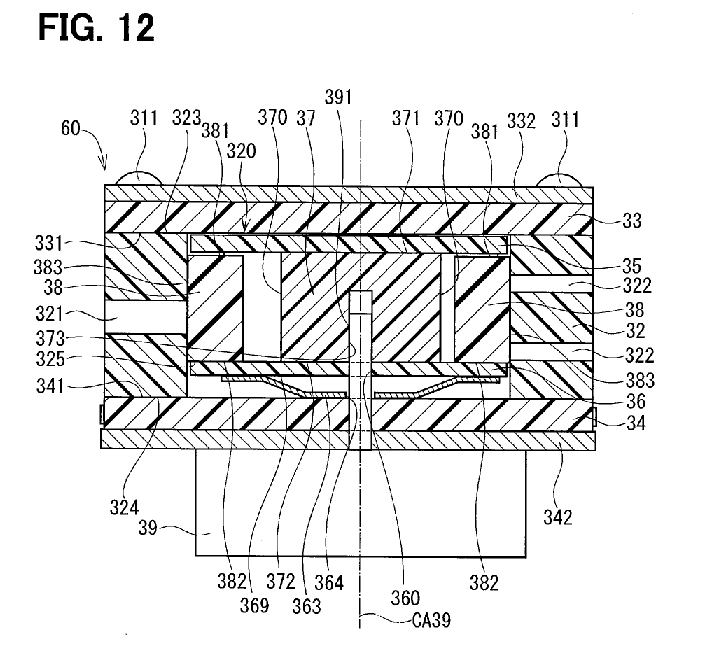

Modifications of the fourth embodiment are shown in FIGS. 11 and 12.

In the modification of FIG. 11, an O-ring 362 is provided in the pump chamber 320 as the second biasing member between the second outer plate 34 and the second inner plate 36. One axial end of the O-ring 362 is in contact with the second axial-inside end surface 341 of the second outer plate 34, while the other axial end of the O-ring 362 is in contact with the second axial-outside end surface 369 of the second inner plate 36. The O-ring 362 biases the second inner plate 36 in a direction to the rotor 37 and the vanes 38. According to the above structure, the same advantages to those of the fourth embodiment can be also obtained. In addition, it is possible to reduce the change of the air suction characteristic and/or the air discharge characteristic of the vane pump 60 depending on the change of its position.

As shown in FIG. 11, a part of the shaft 391 is accommodated in (that is, surrounded by) the O-ring 362. Therefore, it is possible to prevent the O-ring 362 from being displaced in the radial direction of the vane pump 60 between the second inner plate 36 and the second outer plate 34. As a result, the second inner plate 36 is surely in contact with the rotor 37 and/or vanes 38. Furthermore, it is possible to make smaller the air leaking amount from one pumping room 310 to the other pumping room (s) 310 via the gap formed at the shaft-insertion through-hole 360 between the second inner plate 36 and the shaft 391 of the electric motor 39.

In the modification of FIG. 12, a plate spring 363 is provided in the second space “P2” as the second biasing member between the second outer plate 34 and the second inner plate 36. The plate spring 363 is in contact with both of the second axial-inside end surface 341 of the second outer plate 34 and the second axial-outside end surface 369 of the second inner plate 36. The plate spring 363 biases the second inner plate 36 in the direction to the rotor 37 and the vanes 38. According to the above structure, the same advantages to those of the fourth embodiment can be also obtained. In addition, it is possible to reduce the change of the air suction characteristic and/or the air discharge characteristic of the vane pump 60 depending on the change of its position.

As shown in FIG. 12, the plate spring 363 has a shaft-insertion through-hole 364, through which the shaft 391 of the electric motor 39 is inserted. Therefore, it is possible to prevent the plate spring 363 from being displaced in the radial direction of the vane pump 60 in the second space P2 between the second inner plate 36 and the second outer plate 34. As a result, the second inner plate 36 is surely in contact with the rotor 37 and/or vanes 38.

(M3) In the above fourth embodiment (FIG. 7), one coil spring 361 is provided in the second space P2 between the second inner plate 36 and the second outer plate 34. However, the number of the coil springs (the second biasing members), which are provided in the second space P2 between the second inner plate 36 and the second outer plate 34, is not limited to “one”.

(M4) In the above embodiments, each of the first and the second inner plates 35 and 36 is brought into contact with the respective axial end surface of the rotor 37. However, each of the first and the second inner plates 35 and 36 may be brought into contact with the respective axial ends of the vanes 38 or into contact with both of the rotor 37 and the vanes 38. Furthermore, each of the first and the second inner plates 35 and 36 may be located at not a position in the direct contact with the rotor and/or the vanes but a position close to the rotor and the vanes.

(M5) In the above embodiments except for the fourth embodiment, the vane pump has the first biasing member for biasing the first inner plate 35 in the direction to the rotor 37. In the fourth embodiment, the vane pump has the second biasing member for biasing the second inner plate 36 in the direction to the rotor 37. However, the vane pump may have not only the first biasing member but also the second biasing member, so that each of the first and the second inner plates 35 and 36 is respectively biased by the first and the second biasing members to the rotor 37 at the same time.

(M6) In the above seventh embodiment (FIG. 10), the plate spring 356 is formed in the disc shape. However, the plate spring may be formed in any other shapes, for example, an annular shape (a ring shape), wherein a radial-inner peripheral portion thereof is brought into contact with the first outer plate 33, while a radial-outer peripheral portion thereof is brought into contact with the first inner plate 35.

(M7) In the above embodiments, when the rotor 37 is rotated in the forward rotating direction, the air is drawn from the fuel tank 10 and the canister 12. However, the vane pump may increase the pressure in the fuel tank and the canister. In other words, the vane pump may be rotated in either one of the rotating directions, that is, in the forward rotating direction or in a backward rotating direction.

As explained above, the present disclosure is not limited to the above embodiments and/or modifications, but can be further modified in various manners without departing from a spirit of the present disclosure.

What is claimed is:

1. A vane pump comprising:
a pump housing having a pump chamber;
a rotor rotatably accommodated in the pump housing and having a shaft-fixing hole extending in an axial direction of the rotor and multiple vane grooves, each of which extends in a radial-inward direction of the rotor;
multiple vanes, each of which is movably accommodated in the respective vane groove so that each vane is movable in a radial direction of the rotor and in the axial direction of the rotor, each of the vanes being slidable on an inner surface of the housing which forms the pump chamber;
an electric motor having a shaft inserted into the shaft-fixing hole and rotating the rotor;
a first inner plate movably accommodated in the pump chamber between a first axial-end wall of the housing and the rotor as well as the vanes, so that the first inner plate is movable in the axial direction of the rotor in a first space formed between the first axial-end wall and the rotor as well as the vanes, the first space being formed in the pump chamber on an axial side opposite to the electric motor in the axial direction of the rotor; and
a second inner plate movably accommodated in the pump chamber between a second axial-end wall of the housing and the rotor as well as the vanes, so that the second inner plate is movable in the axial direction of the rotor in a second space formed between the second axial-end wall and the rotor as well as the vanes, the second space being formed in the pump chamber on the other axial side to the electric motor in the axial direction of the rotor, the second inner plate having a shaft-insertion through-hole through which the shaft of the electric motor is inserted into the rotor.

2. The vane pump according to claim 1, further comprising:
a first biasing member provided in the first space of the pump chamber between the first axial-end wall and the first inner plate for biasing the first inner plate in the direction to the rotor and the vanes.

3. The vane pump according to claim 2, wherein
the first biasing member is arranged at a position, which is coaxial with a rotating axis of the rotor or a center axis of the first inner plate.

4. The vane pump according to claim 2, wherein
the first biasing member is composed of a coil spring, an elastic member or a plate spring.

5. The vane pump according to claim 2, wherein
the first biasing member is formed in an annular shape.

6. The vane pump according to claim 1, further comprising:
a second biasing member provided in the second space of the pump chamber between the second axial-end wall and the second inner plate for biasing the second inner plate in the direction to the rotor and the vanes.

7. The vane pump according to claim 6, wherein
the second biasing member is formed in an annular shape, wherein the shaft of the electric motor passes through a center of the second biasing member.

8. The vane pump according to claim 6, wherein
the second biasing member is composed of a coil spring, an elastic member or a plate spring.

9. A leakage detecting system for detecting leakage of fuel vapor from a fuel tank of a vehicle comprising:
the vane pump according to claim 1;
a pressure detecting device for detecting pressure in the fuel tank or a canister connected to the fuel tank; and
a control unit for detecting the leakage of the fuel vapor from the fuel tank,
wherein the pressure detecting device detects the pressure in the fuel tank or the canister when the vane pump pressurizes or de-pressurizes fluid in the fuel tank or the canister, and
wherein the control unit compares a detection value of the pressure detecting device with a reference pressure and the control unit determines that the fuel vapor is leaked when the detection value of the pressure detecting device does not reach a predetermined value, which is lower than or higher than the reference pressure by a predetermined amount.
